(19) United States
(12) Patent Application Publication
(10) Pub. No.: US 2021/0294729 A1
(43) Pub. Date: Sep. 23, 2021

(54) REDUCING A TEST SUITE FOR RE-TESTING CONFIGURED INSTANCES IN A PRODUCTION ENVIRONMENT

(71) Applicant: Telefonaktiebolaget LM Ericsson (publ), Stockholm (SE)

(72) Inventors: Maria TOEROE, Montreal (CA); Oussama JEBBAR, Montreal (CA); Mohamed Aymen SAIED, Saint-Leonard (CA); Ferhat KHENDEK, Montreal (CA)

(73) Assignee: Telefonaktiebolaget LM Ericsson (publ), Stockholm (SE)

(21) Appl. No.: 17/254,172

(22) PCT Filed: Jun. 11, 2019
(86) PCT No.: PCT/IB2019/054874

§ 371 Date: Dec. 18, 2020

Related U.S. Application Data
(60) Provisional application No. 62/686,925, filed on Jun. 19, 2018.

(51) Int. Cl. G06F 11/36

(52) U.S. Cl. CPC G06F 11/3684; G06F 11/3664; G06F 11/3688

(57) ABSTRACT

A system configuration is validated in a production environment using test cases selected from a test suite, which has validated a first configuration of the system in a development environment. In response to a change in environments, a reduced set of requirements is formed by removing one or more requirements from a set of requirements against which the first configuration is validated. The removed requirements include environment agnostic requirements. The removing is based on at least a classification of configuration parameters, and a first relation between the requirements and the configuration parameters. A reduced test suite is formed by selecting, from the test suite, the test cases that test the system against the reduced set of requirements. The reduced test suite is applied to a second configuration of the system to validate that the system operates in compliance with the set of requirements in the production environment.

### CROSS-REFERENCE TO RELATED APPLICATIONS

This application claims the benefit of U.S. Provisional Application No. 62/686,925 filed on Jun. 19, 2018.

### TECHNICAL FIELD

Embodiments of the invention relate to software testing; more specifically, to the validation of a configured system in a production environment.

### BACKGROUND

Cloud providers offer a wide variety of services to their tenants. Cloud providers use the same infrastructure to serve multiple tenants, and provide software that can be used under different settings and configurations to accommodate different tenants' requirements (e.g. multi-tenant applications). The shared infrastructure between resources allocated to different tenants may jeopardize the validity of assumptions made regarding the tests performed in the development environment (e.g. resource consumption). This raises several questions regarding the validity in the production environment of the results of tests performed in the development environment. Moreover, the settings, reflected in configurations, used in the production environment are often different from the ones used in the development environment.

In the production environment, a system runs to provide the intended services to customers. This is as opposed to the development environment in which the system runs to verify the correctness of its features that have been implemented.

Changing software settings and redeploying the software in a new environment are scenarios that frequently arise in a cloud environment. To ensure that a reconfiguration has achieved intended goals and has not caused any undesired effects, the system needs to undergo regression tests. Regression test selection techniques have been proposed to avoid the problem of re-running the whole test suite after each reconfiguration, especially with frequently changing configurations and reconfigurations made at customer sites. For fast-growing markets, systems may undergo hundreds of configuration changes every day.

### SUMMARY

In one embodiment, there is provided a method for validating a system configuration in a production environment using test cases selected from a test suite which has validated a first configuration of a system in a development environment. The method comprises: forming a reduced set of requirements in response to a change in environments by removing one or more requirements from a set of requirements against which the first configuration is validated. The removed one or more requirements include at least one or more environment agnostic requirements which are independent of the environments. The removing is based on at least a classification of configuration parameters of the system with respect to dependency of the environments and is further based on a first relation between the set of requirements and the configuration parameters. The method further comprises: forming a reduced test suite by selecting, from the test suite, the test cases that test the system against each requirement in the reduced set of requirements; and applying the reduced test suite to a second configuration of the system to thereby validate that the system operates in compliance with the set of requirements in the production environment.

In another embodiment, there is provided a network node comprising processing circuitry and memory. The memory contains instructions executable by the processing circuitry to validate a system configuration in a production environment using test cases selected from a test suite, which has validated a first configuration of a system in a development environment. The network node is operative to perform the aforementioned method.

In yet another embodiment, there is provided a network node operable to validate a system configuration in a production environment using test cases selected from a test suite, which has validated a first configuration of a system in a development environment. The network node comprises a requirement removal module operative to form a reduced set of requirements in response to a change in environments by removing one or more requirements from a set of requirements against which the first configuration is validated. The removed one or more requirements include at least one or more environment agnostic requirements which are independent of the environments. The removing is based on at least a classification of configuration parameters of the system with respect to dependency of the environments and is further based on a first relation between the set of requirements and the configuration parameters. The network node further comprises a test case selection module operative to form a reduced test suite by selecting, from the test suite, the test cases that test the system against each requirement in the reduced set of requirements. The network node further comprises a test application module operative to apply the reduced test suite to a second configuration of the system to thereby validate that the system operates in compliance with the set of requirements in the production environment.

Other aspects and features will become apparent to those ordinarily skilled in the art upon review of the following description of specific embodiments in conjunction with the accompanying figures.

### BRIEF DESCRIPTION OF THE DRAWINGS

Embodiments will now be described, by way of example only, with reference to the attached figures.

FIG. 1 illustrates an overall approach to test case selection for a production environment according to one embodiment.

FIG. 2 is a diagram illustrating inputs to a test case selection method according to one embodiment.

FIG. 3 illustrates further details of the test selection method of FIG. 2 according to one embodiment.

FIG. 4 is a flow diagram illustrating a method for test case selection according to an embodiment.

FIG. 5 is a block diagram of a network node according to one embodiment.

FIG. 6 is a block diagram of a network node according to another embodiment.

FIG. 7 is an architectural overview of a cloud computing environment according to one embodiment.

### DETAILED DESCRIPTION

Reference may be made below to specific elements, numbered in accordance with the attached figures. The discussion below should be taken to be exemplary in nature, and should not be considered as limited by the implementation details described below, which as one skilled in the art will appreciate, can be modified by replacing elements with equivalent functional elements.

Configurations play an important role in the behavior and operation of configurable systems. Prior to deployment in a production environment, a configured system may be tested in a development environment. Due to the differences between the two environments, the system is reconfigured to adapt to the production environment and is re-tested in the production environment.

A test case selection method is disclosed herein. The method improves efficiency and reduces costs of testing a system configuration in a new environment (e.g. the production environment). Since the system has already been tested in the development environment, it is not necessary to re-apply all the test cases that have been used in the development environment. The method and the network nodes performing the method disclosed herein validate a system configuration using a reduced test suite, when the system is reconfigured to operate in a second environment (e.g. the production environment) different from a first environment (e.g. the development environment).

In one embodiment, the reduced test suite is formed by removing a number of test cases from a test suite which has been used to validate a first configuration of the system in the development environment against a set of requirements. The reduced test suite validates a second configuration of the system for operating in the production environment in compliance with the set of requirements. The test cases are removed based on a classification of configuration parameters, the relation between the configuration parameters and the requirements, and the relation between the requirements and the test cases. These relations help to determine which requirements need to be re-tested in the production environment and, therefore, the appropriate test cases can be retained for the re-tests.

The definitions of some of the terminologies used throughout the disclosure are provided below.

Configurable system: a configurable system is a system that cannot be used without a configuration. This configuration may be used to compile the code of the system (e.g. a Linux® kernel configuration), launch an instance of the system, or parametrize the services that the system provides at runtime (e.g. a firewall configuration).

Configuration: a configuration is a set of (key, value) pairs, each of which represents a system function parameter identified by the key and its associated value in the given configuration. The parameter values do not change during system normal operation, i.e. when no bug is detected and no new feature is requested. These parameters are referred to as configuration parameters (cp).

Configured instance: a configured instance is a system resulting from configuring a configurable system for a given purpose and the resulting system is ready to use for the purpose. A configured instance is usually used to satisfy a refined subset of the requirements (reflecting the purpose) of the configurable system. A subset of the configuration parameters is set to satisfy these refined requirements.

Test case (tc): a set of conditions, interactions with the system under test (configured instance) and expected result derived from (and related to) one or several requirements.

Test suite (TS): a set of test cases to validate the system under test (configured instance) against the requirements. This disclosure focuses on acceptance testing of configured instances.

Coverage matrix: a relation between the test cases in a test suite and the requirements. A test case can map into many requirements as well as a requirement can be covered in many test cases. A coverage matrix may be created by an acceptance test designer.

Impact matrix: a matrix that captures the relation between the requirements and the configuration parameters. An impact matrix may be set by a configuration designer.

Some assumptions made in this disclosure are provided below. An error can be caused either by fault(s) in the code of the configurable system or fault(s) in the configuration. It is assumed that the system has been tested properly in the development environment and passed the acceptance test suite. Thus, it is assumed that the code of the configurable system is validated with respect to the test suite, and the configuration is the suspicious artifact in case of errors in the production environment.

Changes to a configuration lead to a new configured instance of the system. Therefore, the process of testing is reinitiated for the new configured instance. It is assumed that the configuration remains unchanged during testing.

Table 1 illustrates four scenarios of requirement refinements for a configurable system in an e-commerce application. Each row of Table 1 corresponds to one scenario. For each scenario, the last column of Table 1 provides the system's configuration settings that satisfy the requirements. In the first scenario, the configuration controls the presence or absence of features of the configurable system in the configured instance. The second scenario is a specialization at a functional level, and the third scenario is a specialization at a non-functional level. The last scenario covers refinement of accessibility aspects (e.g. access to the services exposed by the configured instance, or the service that the configured instance may need to provide its services properly).

TABLE 1
Refinements of Requirements for a Configurable System

| | Requirement on the | Requirement on a | Manifestation in the |
|---|---|---|---|
| | configurable system | configured instance | configuration |
| 1. Activation or | Payment per credit card is an | An e-commerce | A Boolean configuration |
| deactivation | optional feature in the | application that allows | parameter set to “true” or |
| | configurable system. | payment per credit card. | “1” (e.g. cc_payment = true). |
| 2. Refinement of a | The number of items per cart | An e-commerce | An integer configuration |
| function | should not exceed a pre-set | application that allows for | parameter set to 10 (e.g. |
| | number. | up to 10 items per cart. | max_item_per_cart = 10). |
| 3. Refinement of an | The duration for which the | An e-commerce | An integer configuration |
| interaction | system waits for confirmation | application for which the | parameter set to a duration |
| | of a monetary transaction | processing of the payment | in a time unit (e.g. if time |
| | should not exceed a pre-set | should not exceed 1 | unit is seconds, we can have |
| | number. | minute. | a configuration parameter |
| | | | set as follows: |
| | | | transaction_timeout = 60*). |
| 4. Refinement of | The credit card payment if | An e-commerce | An integer configuration |
| accessibility | activated should be | application that allows | parameter holding the port |
| | accessible using TCP through | payment per credit card. | number (e.g. |
| | a pre-set port. | | cc_service_port = 1025) |

A test selection method is described herein for selecting a reduced test suite to be executed in a production environment for validating a system with a second configuration. The reduced test suite is selected from a test suite that has been executed in a development environment to validate the system with a first configuration. This selection is performed by identifying and eliminating those test cases that do not need to be repeated in a new environment (e.g. the production environment). The selection is based on a classification of configuration parameters, a mapping between the requirements and the configuration parameters, and a mapping between the test cases and the requirements.

The classification of configuration parameters is described below. Configuration parameters may be classified into two categories: environment agnostic configuration parameters and environment dependent configuration parameters. This classification is an input to the test case selection method. In some embodiments, the number of configuration parameters may be in the hundreds.

An environment agnostic configuration parameter is independent of the environment of the configured instance. To satisfy a requirement, the value of an environment agnostic parameter can be set independently from the environment in which the configured instance is deployed. Typically, a configuration parameter has the same value (or a range of values) for all configured instances that satisfy a requirement related to this configuration parameter (e.g. the first two scenarios in Table 1). The values of the environment agnostic configuration parameters in the development environment are not changed for the production environment.

An environment dependent configuration parameter is dependent on the environment of the configured instance. In other words, to satisfy a requirement, the value of an environment dependent configuration parameter depends on the configured instance's environment (e.g. the last two scenarios in Table 1).

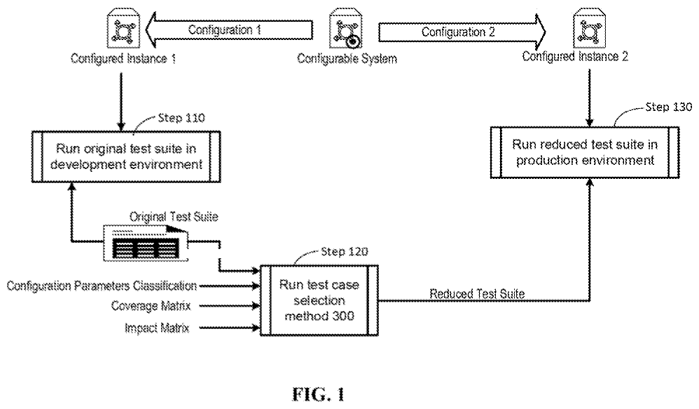

FIG. 1 illustrates an overall approach to test case selection according to one embodiment. As illustrated at step 110 of FIG. 1, a configured instance (Configured Instance1) of a configurable system is tested using a test suite (“original test suite”) in a development environment. The system is then deployed in a production environment. The configuration (Configuration2) of the system in the production environment is different from the configuration (Configuration1) of the system in the development environment. However, environment agnostic configuration parameters in both Configuration1 and Configuration2 stay the same. Before testing the system in the production environment, a test case selection method 300 is performed at step 120 to produce a reduced test suite. At step 130, a configured instance (Configured Instance2) of the system is tested using the reduced test suite.

It is noted that both configured instances (e.g. Configured Instance1 and Configured Instance2) satisfy the same requirements. The differences between both Configuration1 and Configuration2 result from the environment in which the system operates. For example, in the last scenario of Table 1 (i.e. the last row), the port through which credit card payments are accessible may depend on the available ports in the given environment. Similarly, in the third scenario of Table 1 (i.e. the third row), the payment processing time may depend on the location and the connection type (e.g. the connection speed) used in the given environment.

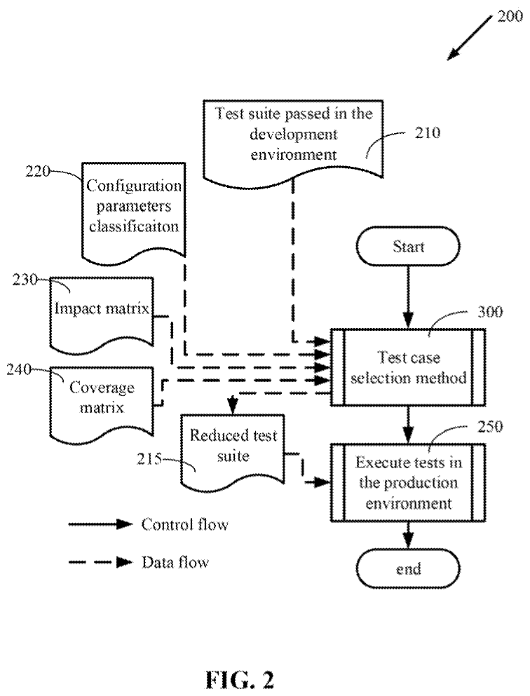

FIG. 2 is a diagram illustrating the control and data flows of the test case selection method 300 of FIG. 1 according to one embodiment. The control flows are indicated by solid lines and the data flows are indicated by dashed lines. The test case selection method 300 receives four inputs including: a test suite 210 (i.e. the original test suite in FIG. 1); a classification of the configuration parameters 220, an impact matrix 230, and a coverage matrix 240. Prior to the execution of the test case selection method, the test suite 210 has already been applied to a system in the development environment and the system has passed the tests in the test suite 210. Based on these inputs, the test case selection method 300 outputs a reduced test suite 215 for testing the system in the production environment.

The impact matrix 230 captures the relation of the requirements and the configuration parameters. In one embodiment, the impact matrix 230 has each requirement in one row (or column) and each configuration parameter in one column (or row). Each cell in the impact matrix 230 indicates whether a corresponding requirement maps to a corresponding configuration parameter; i.e. whether the corresponding requirement is realized through at least this corresponding configuration parameter. The coverage matrix 240 captures the relation of the test cases and the requirements. In one embodiment, the coverage matrix 240 has each test case in one row (or column) and each requirement in one column (or row). Each cell in the coverage matrix indicates whether a corresponding test case maps to a corresponding requirement; i.e. whether the corresponding test case tests a system against at least this corresponding requirement. It is understood that the mapping or relation may be recorded in a data structure different from a matrix in an alternative embodiment.

From the classification of the configuration parameters 220 and the impact matrix 230, three categories of requirements can be defined below. The first category is environment agnostic requirements, which map to environment agnostic configuration parameters only. The second category is environment dependent requirements, which map to environment dependent configuration parameters only; e.g. the requirements related to system interfaces for interacting with the environment. The third category is composite requirements, which map to both environment agnostic and environment dependent configuration parameters.

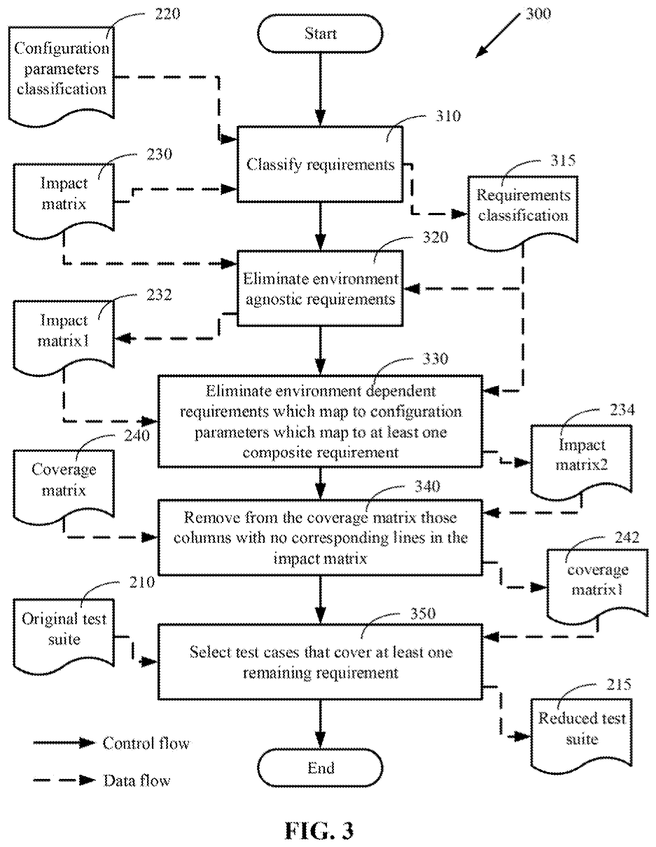

FIG. 3 is a diagram illustrating further details of the test case selection method 300 according to one embodiment. The method 300 starts with step 310 when a requirements classification 315 is generated based on the configuration parameters classification 220 and the impact matrix 230. The requirements are classified into the three aforementioned categories; i.e. environment agnostic requirements, environment dependent requirements and composite requirements. At step 320, the impact matrix 230 is reduced by eliminating from it all the environment agnostic requirements, as there is no need to re-test the environment agnostic requirements in a new environment. The resulting impact matrix is an impact matrix1 232, which is further reduced at step 330 into an impact matrix2 234 using the information from the requirements classification 315. All the composite requirements remain in the impact matrix2 234. At step 330, the impact matrix1 232 is reduced by removing each environment dependent requirement which satisfies the following criterion: the environment dependent requirement maps to one or more environment dependent configuration parameters and the one or more environment dependent configuration parameters further map to at least one composite requirement. For an environment dependent requirement to be eliminated at this step, its environment dependent configuration parameter needs to map to a composite requirement. If there are multiple environment dependent configuration parameters of the environment dependent requirement, it is not necessary that these environment dependent configuration parameters map to the same composite requirement. The environment dependent requirement is eliminated if all of its environment dependent parameters are mapped into one or more composite requirements. Such an environment dependent requirement is for the interactions with the environment and has been covered in test cases related to composite requirements.

The requirements that remain in the impact matrix2 234 are referred to as the remaining requirements, which form a reduced set of requirements. The reduced set of requirements is used in the next steps to identify the reduced test suite 215. It is assumed in the following description that the coverage matrix 240 is arranged to have all the requirements along the column dimension and all the test cases in the test suite along the row dimension. It is understood that the requirements may be arranged along the row dimension and the test cases may be arranged along the column dimension in an alternative embodiment.

At step 340, all the columns of the coverage matrix 240 that correspond to the requirements dropped at steps 320 and 330 are removed from the coverage matrix 240 to form a reduced coverage matrix (i.e. coverage matrix1 242). That is, only the reduced set of requirements remains in the coverage matrix1 242. At step 350, the test cases covering at least one remaining requirement in the coverage matrix1 242 are selected. However, if the same requirement or requirements are covered by the same two or more test cases, only one of these test cases is selected. The method 300 ensures that at least one test case is selected for each environment dependent configuration parameter. The selected test cases form the reduced test suite 215.

An example is presented below to illustrate the test case selection method 300 with a test suite TS={tc₁, tc₂, tc₃, tc₄, tc₅, tc₆}. The coverage matrix and the impact matrix are given in Table 2 and Table 3, respectively. Each cell marked with x indicates that a relation (i.e. mapping) exists between its corresponding column and row.

TABLE 2
Example of a Coverage Matrix

| | Req₁ | Req₂ | Req₃ | Req₄ | Req₅ |
|---|---|---|---|---|---|
| tc₁ | x | | | | |
| tc₂ | | x | | | |
| tc₃ | | | x | | |
| tc₄ | | | | x | |
| tc₅ | | | | | x |
| tc₆ | x | | x | | |

TABLE 3
Example of an Impact Matrix

| | cp₁ | cp₂ | cp₃ | cp₄ |
|---|---|---|---|---|
| Req₁ | | x | | x |
| Req₂ | x | | | |
| Req₃ | | | x | |
| Req₄ | | x | x | x |
| Req₅ | x | x | | |

In this example, it is assumed that cp₁ and cp₃ are environment agnostic, and cp₂ and cp₄ are environment dependent. According to the impact matrix in Table 3, the requirements are categorized as follows. Req₁ is environment dependent, Req₂ and Req₃ are environment agnostic, and Req₄ and Req₅ are composite requirements. Therefore, Req₂ and Req₃ can be removed from the impact matrix, and Req₄ and Req₅ are selected. Req₁, an environment dependent requirement, maps to two configuration parameters that Req₄ also maps to. Req₄ is a composite requirement already selected. Therefore, Req₁ is dropped. As a result, the reduced impact matrix consists of Req₄ and Req₅.

After the columns corresponding to Req₁, Req₂ and Req₃ are removed from the coverage matrix, only Req₄ and Req₅ are left in the coverage matrix. The test cases that cover Req₄ and Req₅ are tc₄ and tc₅, which form the reduced test suite for the production environment.

This disclosure provides a method for validating a system configuration in the production environment using test cases selected from a test suite which has been used to test a system in the development environment. The test case selection method reduces the test suite by utilizing the configuration parameters classified with respect to dependency on environments. Thus, when testing a configurable system in the production environment, a tester can re-use the results of the tests already performed in the development environment. Thus, testing a configurable system in the production environment becomes more efficient and less costly.

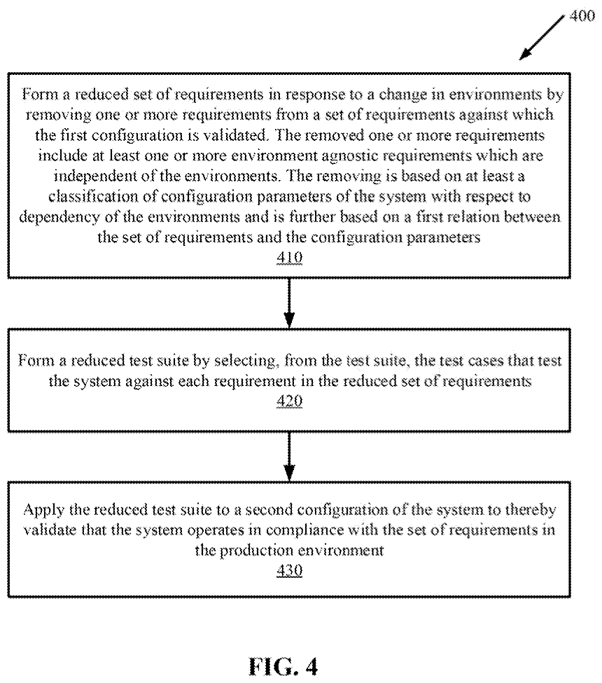

FIG. 4 is a flow diagram illustrating a method 400 for validating a system configuration in a production environment using test cases selected from a test suite, which has validated a first configuration of a system in a development environment. The method 400 begins at step 410 with forming a reduced set of requirements in response to a change in environments. The reduced set of requirements may be formed by removing one or more requirements from a set of requirements against which the first configuration is validated. The removed requirements include at least one or more environment agnostic requirements which are independent of the environments. The removing is based on at least a classification of configuration parameters of the system with respect to dependency on the environments and is further based on a first relation between the set of requirements and the configuration parameters.

At step 420, a reduced test suite is formed by selecting, from the test suite, the test cases that test the system against each requirement in the reduced set of requirements. At step 430, the reduced test suite is applied to a second configuration of the system to thereby validate that the system operates in compliance with the set of requirements in the production environment.

In one embodiment, the inputs to the method 400 include an impact matrix, which captures the first relation; i.e. the relation between the set of requirements and the configuration parameters. The impact matrix may have the set of requirements along a first dimension and the configuration parameters along a second dimension.

In one embodiment, the configuration parameters are classified into environment dependent configuration parameters and environment agnostic configuration parameters. The environment agnostic configuration parameters are independent of the environment in which the system is deployed. The first configuration and the second configuration of the system have the same values for the environment agnostic configuration parameters. Based on the classified configuration parameters, the requirements in the set of requirements are classified into environment agnostic requirements, environment dependent requirements and composite requirements. Each composite requirement maps to at least one environment agnostic configuration parameter and at least one environment dependent configuration parameter. All of the composite requirements are retained in the reduced set of requirements.

In one embodiment, in addition to the one or more environment agnostic requirements, the requirements removed from the set of requirements further include at least an environment dependent requirement, which maps to a set of environment dependent configuration parameters and the set of environment dependent configuration parameters map to at least a composite requirement. In one embodiment, the environment dependent requirement is removed when a first configuration parameter and a second configuration parameter in the set of environment dependent configuration parameters map to different composite requirements.

In one embodiment, the inputs to the method 400 further include a coverage matrix, which relates test cases in the test suite to the set of requirements. The coverage matrix may have the test cases along a first dimension and the set of requirements along a second dimension. The reduced test suite is formed by selecting the test cases that cover the reduced set of requirements using the information in the coverage matrix.

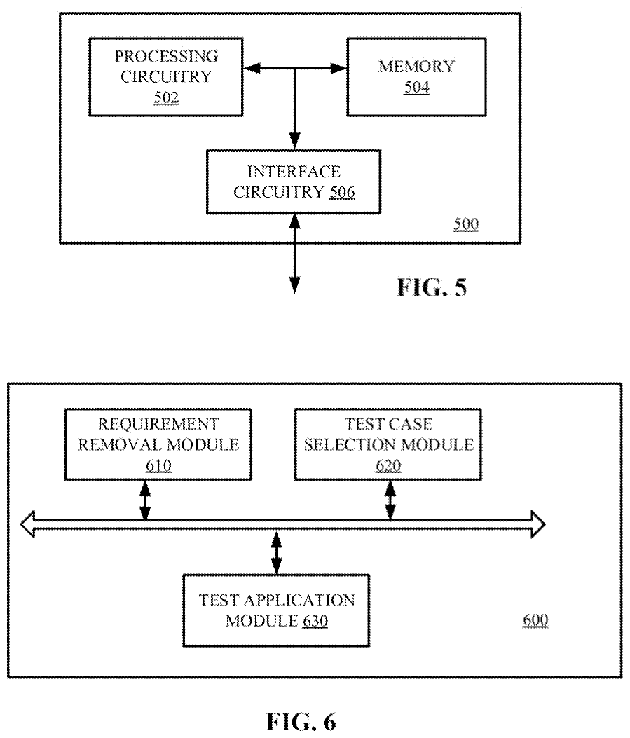

FIG. 5 is a block diagram illustrating a network node 500 according to an embodiment. In one embodiment, the network node 500 may be a server in an operator network or in a data center. The network node 500 includes circuitry which further includes processing circuitry 502, a memory 504 or instruction repository and interface circuitry 506. The interface circuitry 506 can include at least one input port and at least one output port. The memory 504 contains instructions executable by the processing circuitry 502 whereby the network node 500 is operable to perform the various embodiments described herein, including the method 400 described with reference to FIG. 4.

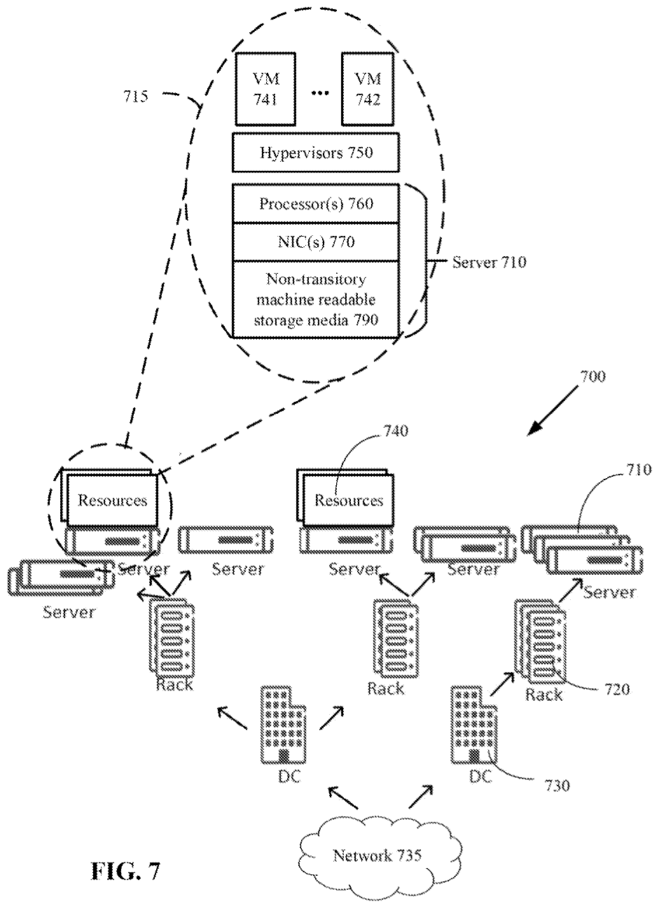

FIG. 6 is a block diagram of an example network node 600 for validating a system configuration in a production environment according to one embodiment. The system configuration in the production environment is validated using test cases selected from a test suite which has validated a first configuration of the system in a development environment. In one embodiment, the network node 600 may be a server in an operator network or in a data center. The network node 600 includes a requirement removal module 610 operative to form a reduced set of requirements in response to a change in environments; a test case selection module 620 operative to form a reduced test suite; and a test application module 630 operative to apply the reduced test suite to a second configuration of the system to thereby validate that the system operates in compliance with the set of requirements in the production environment. More specifically, referring to the method 400 of FIG. 4, the requirement removal module 610 is operative to perform step 410, the test case selection module 620 is operative to perform step 420, and the test application module 630 is operative to perform step 430 of the method 400. The network node 600 can be configured to perform the various embodiments as have been described herein.

FIG. 7 is an architectural overview of a cloud computing environment 700 that comprises a hierarchy of a cloud computing entities. The cloud computing environment 700 can include a number of different data centers (DCs) 730 at different geographic sites connected over a network 735. Each data center 730 site comprises a number of racks 720, each rack 720 comprises a number of servers 710. It is understood that in alternative embodiments a cloud computing environment may include any number of data centers, racks and servers. A set of the servers 710 may be selected to host resources 740. In one embodiment, the servers 710 provide an execution environment for hosting entities and their hosted entities, where the hosting entities may be service providers and the hosted entities may be the services provided by the service providers. Examples of hosting entities include virtual machines (which may host containers) and containers (which may host contained components), among others. A container is a software component that can contain other components within itself. Multiple containers can share the same operating system (OS) instance, and each container provides an isolated execution environment for its contained component. As opposed to VMs, containers and their contained components share the same host OS instance and therefore create less overhead. Each of the servers 710, the VMs, and the containers within the VMs may be configured to perform the various embodiments as have been described herein.

Further details of the server 710 and its resources 740 are shown within a dotted circle 715 of FIG. 7, according to one embodiment. The cloud computing environment 700 comprises a general-purpose network device (e.g. server 710), which includes hardware comprising a set of one or more processor(s) 760, which can be commercial off-the-shelf (COTS) processors, dedicated Application Specific Integrated Circuits (ASICs), or any other type of processing circuit including digital or analog hardware components or special purpose processors, and network interface controller(s) 770 (NICs), also known as network interface cards, as well as non-transitory machine-readable storage media 790 having stored therein software and/or instructions executable by the processor(s) 760.

During operation, the processor(s) 760 execute the software to instantiate a hypervisor 750 and one or more VMs 741, 742 that are run by the hypervisor 750. The hypervisor 750 and VMs 741, 742 are virtual resources, which may run node instances in this embodiment. In one embodiment, the node instance may be implemented on one or more of the VMs 741, 742 that run on the hypervisor 750 to perform the various embodiments as have been described herein. In one embodiment, the node instance may be instantiated as a network node performing the various embodiments as described herein.

In an embodiment, the node instance instantiation can be initiated by a user 701 or by a machine in different manners. For example, the user 701 can input a command, e.g., by clicking a button, through a user interface to initiate the instantiation of the node instance. The user 701 can alternatively type a command on a command line or on another similar interface. The user 701 can otherwise provide instructions through a user interface or by email, messaging or phone to a network or cloud administrator, to initiate the instantiation of the node instance.

Embodiments may be represented as a software product stored in a machine-readable medium (such as the non-transitory machine-readable storage media 790, also referred to as a computer-readable medium, a processor-readable medium, or a computer usable medium having a computer readable program code embodied therein). The non-transitory machine-readable medium 790 may be any suitable tangible medium including a magnetic, optical, or electrical storage medium including a diskette, compact disk read only memory (CD-ROM), digital versatile disc read-only memory (DVD-ROM) memory device (volatile or non-volatile) such as hard drive or solid state drive, or similar storage mechanism. The machine-readable medium may contain various sets of instructions, code sequences, configuration information, or other data, which, when executed, cause a processor to perform steps in a method according to an embodiment. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope which is defined solely by the claims appended hereto.

1. A method for validating a system configuration in a production environment using test cases selected from a test suite, which has validated a first configuration of a system in a development environment, the method comprising:
forming a reduced set of requirements in response to a change in environments by removing one or more requirements from a set of requirements against which the first configuration is validated, wherein the removed one or more requirements include at least one or more environment agnostic requirements which are independent of the environments, and wherein the removing is based on at least a classification of configuration parameters of the system with respect to dependency of the environments and is further based on a first relation between the set of requirements and the configuration parameters;
forming a reduced test suite by selecting, from the test suite, the test cases that test the system against each requirement in the reduced set of requirements; and
applying the reduced test suite to a second configuration of the system to thereby validate that the system operates in compliance with the set of requirements in the production environment.

2. The method of claim 1, further comprising:
receiving inputs including an impact matrix which captures the first relation, wherein the impact matrix having the set of requirements along a first dimension and the configuration parameters along a second dimension.

3. The method of claim 1, further comprising:
classifying the configuration parameters into environment dependent configuration parameters and environment agnostic configuration parameters, wherein the environment agnostic configuration parameters are independent of an environment in which the system is deployed.

4. The method of claim 3, wherein the first configuration and the second configuration have same values for environment agnostic configuration parameters.

5. The method of claim 3, further comprising:
classifying, based on the classified configuration parameters, the set of requirements into environment agnostic requirements, environment dependent requirements and composite requirements, wherein each composite requirement maps to at least one environment agnostic configuration parameter and at least one environment dependent configuration parameter.

6. The method of claim 5, further comprising:
retaining all of the composite requirements in the reduced set of requirements.

7. The method of claim 1, wherein the removed one or more requirements further include at least an environment dependent requirement, which maps to a set of environment dependent configuration parameters and the set of environment dependent configuration parameters map to at least a composite requirement, wherein the composite requirement maps to at least one environment agnostic configuration parameter and at least one environment dependent configuration parameter.

8. The method of claim 7, wherein the environment dependent requirement is removed when a first configuration parameter and a second configuration parameter in the set of environment dependent configuration parameters map to different composite requirements.

9. The method of claim 1, further comprising:
receiving inputs including a coverage matrix relating the test cases in the test suite to the set of requirements, wherein the coverage matrix having the test cases along a first dimension and the set of requirements along a second dimension.

10. The method of claim 9, wherein forming the reduced test suite further comprises: selecting the test cases that cover the reduced set of requirements using information in the coverage matrix.

11. A network node comprising:
processing circuitry; and
memory containing instructions executable by the processing circuitry to validate a system configuration in a production environment using test cases selected from a test suite, which has validated a first configuration of a system in a development environment, the network node operative to:
form a reduced set of requirements in response to a change in environments by removing one or more requirements from a set of requirements against which the first configuration is validated, wherein the removed one or more requirements include at least one or more environment agnostic requirements which are independent of the environments, and wherein the removing is based on at least a classification of configuration parameters of the system with respect to dependency of the environments and is further based on a first relation between the set of requirements and the configuration parameters;
form a reduced test suite by selecting, from the test suite, the test cases that test the system against each requirement in the reduced set of requirements; and
apply the reduced test suite to a second configuration of the system to thereby validate that the system operates in compliance with the set of requirements in the production environment.

12. The network node of claim 11, wherein the network node is further operative to:
receive inputs including an impact matrix which captures the first relation, wherein the impact matrix having the set of requirements along a first dimension and the configuration parameters along a second dimension.

13. The network node of claim 11, wherein the network node is further operative to:
classify the configuration parameters into environment dependent configuration parameters and environment agnostic configuration parameters, wherein the environment agnostic configuration parameters are independent of an environment in which the system is deployed.

14. The network node of claim 13, wherein the first configuration and the second configuration have same values for environment agnostic configuration parameters.

15. The network node of claim 13, wherein the network node is further operative to:
classify, based on the classified configuration parameters, the set of requirements into environment agnostic requirements, environment dependent requirements and composite requirements, wherein each composite requirement maps to at least one environment agnostic configuration parameter and at least one environment dependent configuration parameter.

16. The network node of claim 15, wherein the network node is further operative to:
retain all of the composite requirements in the reduced set of requirements.

17. The network node of claim 11, wherein the removed one or more requirements further include at least an environment dependent requirement, which maps to a set of environment dependent configuration parameters and the set of environment dependent configuration parameters map to at least a composite requirement, wherein the composite requirement maps to at least one environment agnostic configuration parameter and at least one environment dependent configuration parameter.

18. The network node of claim 17, wherein the environment dependent requirement is removed when a first configuration parameter and a second configuration parameter in the set of environment dependent configuration parameters map to different composite requirements.

19. The network node of claim 11, wherein the network node is further operative to:
receive inputs including a coverage matrix relating the test cases in the test suite to the set of requirements, wherein the coverage matrix having the test cases along a first dimension and the set of requirements along a second dimension.

20. (canceled)

21. A network node operable to validate a system configuration in a production environment using test cases selected from a test suite, which has validated a first configuration of a system in a development environment, the network node comprising:
a requirement removal module operative to form a reduced set of requirements in response to a change in environments by removing one or more requirements from a set of requirements against which the first configuration is validated, wherein the removed one or more requirements include at least one or more environment agnostic requirements which are independent of the environments, and wherein the removing is based on at least a classification of configuration parameters of the system with respect to dependency of the environments and is further based on a first relation between the set of requirements and the configuration parameters;
a test case selection module operative to form a reduced test suite by selecting, from the test suite, the test cases that test the system against each requirement in the reduced set of requirements; and
a test application module operative to apply the reduced test suite to a second configuration of the system to thereby validate that the system operates in compliance with the set of requirements in the production environment.
